(19) United States
(12) Patent Application Publication
(10) Pub. No.: US 2003/0013801 A1
(43) Pub. Date: Jan. 16, 2003

(54) Single component sealant in a dispersion in cartridges

(76) Inventors: Reto Sieber, Miramar (CH); Marco Sieber, Horw (CH); Patrick Vandeweerdt, Hunenberg (CH)

Correspondence Address: MICHAEL BEST & FRIEDRICH, LLP, ONE SOUTH PINCKNEY STREET, P O BOX 1806, MADISON, WI, 53701

(21) Appl. No.: 10/181,118

(22) PCT Filed: Jan. 10, 2001
(86) PCT No.: PCT/EP01/00235

(51) Int. Cl. C08L 33/06

(52) U.S. Cl. 524/560; 524/561

(57) ABSTRACT

One-component sealant based on a dispersion of vinyl polymers, the sealant in the wet state being substantially free from volatile organic compounds (VOCs) and in the dry state being self-adhesive. The sealant is especially suitable for connecting polyolefin materials.

The invention relates to a one-component sealant based on a dispersion of vinyl polymers, the sealant in the wet state being substantially free from volatile organic compounds and in the dry state being self-adhesive. The invention further relates to the preparation and use of this sealant and to materials coated with this sealant.

The joining of materials is generally subdivided into adhesive bonding and sealing. The sealing of materials is an application which is encountered in all segments from the metal-processing industry through to the construction segment. The function of sealants is to accommodate movements which occur between components, for example, and to close the joints. Joints must be closed in order that no solids, liquids or gases can penetrate to the wrong place. With adhesives, on the other hand, the primary function is to produce a bond and so the adhesion properties and strength of the adhesives come to the fore. Adhering and sealing compositions for the joining of substrates can be differentiated according to their consistency: solid, elastic or plastic. With decreasing tensile shear strength, the extension of the composition passes through a maximum, with the composition undergoing transition from solid via elastic through to the plastic region. The consistency of the composition determines whether it is referred to as an adhesive (solid to elastic) or a sealant (elastic to plastic). Thus an adhesive must possess a certain tensile strength in order that structural adhesive bonds can be successfully performed. With sealants, on the other hand, the compositions used are basically compositions with elastic properties that possess a certain expansion capacity, in order to be able to accommodate expansions and shrinkages, so that no cracks or fractures, and hence leaks, are developed. The known sealants have the property of curing following their application, so that no dirt remains adhering to the surface.

In the construction segment, for the purpose of scaling polyolefin materials, e.g., polyethylene films, sealants are known which are solvent-based and which therefore contain volatile organic compounds. Because of environmental considerations and also on account of their strong odor, sealants of this kind are coming up against ever increasing resistance, and more recent developments are aiming at substantially solvent-free sealants.

Accordingly, the object on which the invention was based was to provide a sealant whose volatile organic compound content is as low as possible and which achieves effective sealing of polyolefin materials.

For achieving this object a one-component sealant is proposed which is substantially free from volatile organic compounds, is based on a dispersion of vinyl polymers, and is self-adhesive in the dry state.

The invention accordingly provides a one-component sealant based on a dispersion of vinyl polymers, the sealant in the wet state being substantially free from volatile organic compounds and in the dry state being self-adhesive. The invention further provides for the preparation of the sealant of the invention and for its use for connecting and/or sealing materials, especially polyolefin materials, and also provides materials coated with the sealant of the invention. Preferred embodiments of the invention are defined in the dependent claims and in the following description.

The sealant of the invention is self-adhesive in the dry state. The tackiness of the surface of the sealant can be measured in accordance with Test Methods for Pressure-Sensitive Adhesives, 6th edition, Pressure sensitive tape council, Itasca III using a traveling ball whose path is less than about 30 cm, preferably less than about 20 cm. Fundamentally, the sealant of the invention after drying is always self-adhesive; in other words, an adhesive bond can be achieved at any time, even after drying, and the self-adhesive property is conserved.

Suitable vinyl polymers include all polymers based on at least one of the monomers which are described in Handbook of Pressure Sensitive Technology, 2nd edition, Donatas Satas, 1989, Van Nostrand Reinhold, 0-442-28026-2, page 444 to 450. Particularly suitable vinyl polymers are those based on at least acrylate and/or methacrylate monomers, for reasons including in particular their aging stability. These acrylate- and/or polymethacrylate-based polymers, if comprising further monomers, preferably contain vinyl-based monomers, e.g. vinyl acetate, vinyl ethers, vinyl halides or vinylaromatic compounds, e.g., styrene or vinylbenzene, or aliphatic monomers, e.g., ethene, butadiene or propene. Polyacrylates and/or polymethacrylates with ester groups having from about 1 to about 15 carbon atoms are particularly suitable. Greatest preference is given to using polyacrylates based on 2-ethylhexyl acrylate and/or butyl acrylate. Polyvinyl compounds that are suitable in accordance with the invention are prepared by dispersion polymerization, which is known to the skilled worker. Thus commercially available polyacrylate dispersions customarily contain from about 30 to about 60% by weight of water and from about 40 to about 70% by weight of polyacrylates plus additives where appropriate.

In the wet state the sealant appropriately comprises vinyl polymers dispersed in an aqueous medium. Inventively preferred sealants contain in the wet state from about 15 to about 90% by weight, preferably from about 25 to about 80% by weight, in particular from about 30 to about 50% by weight of vinyl polymers and from about 5 to about 50% by weight, preferably from about 5 to about 40% by weight, in particular from about 15 to about 30% by weight of aqueous medium, based in each case on 100% by weight of sealant in the wet state, the remainder in each case being additives. The aqueous medium comprises water and, where appropriate, water-soluble additives. These additives are added for purposes including improving the frost resistance of the sealant. Depending on the amount added, which can easily be determined by the skilled worker, the freezing temperature can be reduced down to −20° C. The additives in question here are preferably water-soluble inorganic salts, especially sodium chloride, potassium chloride, calcium chloride or sodium sulfate, or water-soluble solvents, especially methanol, ethanol, propanol or acetone, or water-soluble high-boiling and/or plasticizing compounds, especially ethylene glycol or propylene glycol. Said water-soluble additives may be used alone or as mixtures.

The sealant may comprise additives selected from inorganic fillers; organic fillers, especially plasticizers, tackifiers, oligomeric fillers, polymeric fillers, and rheology modifiers, such as thickeners or thixotropic agents, for example; crosslinkers; adhesion promoters; stabilizers; defoamers; surfactants; drying additives; volatile organic compounds (VOCs); and the abovementioned water-soluble additives. The additives can be used alone or as mixtures. They are present in the following amounts, based in each case on 100 parts by weight of sealant in the wet state: from about 0 to about 80 parts by weight of organic and/or inorganic fillers; from about 0 to about 60 parts by weight of plasticizers; from about 0 to about 80 parts by weight of tackifiers; from about 0 to about 80 parts by weight of oligomeric and/or polymeric fillers; from about 0 to about 20 parts by weight of rheology modifiers; from about 0 to about 15 parts by weight of crosslinkers; from about 0 to about 10 parts by weight of adhesion promoters; from about 0 to about 15 parts by weight of stabilizers, from about 0 to about 10 parts by weight of defoamers; from about 0 to about 10 parts by weight of surfactants; from about 0 to about 20 parts by weight of drying additives; and from about 0 to about 10 parts by weight of volatile organic compounds (VOCs), preferably from about 0 to about 5 parts by weight of volatile organic compounds (VOCs), in particular from about 0 to about 3 parts by weight of volatile organic compounds (VOCs). The respective additives are additives which are known to the skilled worker in this field and which individually are not subject to any particular restrictions. Preferred inorganic fillers are precipitated or natural barium sulfate, titanium dioxide, precipitated or natural calcium carbonate (e.g., chalk), precipitated or natural kaolin, talc, magnesium hydroxide or aluminum hydroxide (the latter hydroxides allow the fire class to be adjusted), zinc oxide, zirconium salts, glass beads or hollow microbeads of all kinds. Preferred organic fillers are, for example, resins based on hydrocarbons or on rosin, tall resin, balsam resin, terpenes, oligomers, such as butylenes, for example, acrylates or other vinyl-based molecules having a relatively low molecular weight, urethanes or esters having a relatively low molecular weight, or polyester-based polymeric plasticizers, e.g., Benzoflex. Suitable organic fillers also include polymeric fillers, such as impact modifiers, polymer fibers or polymer powders of polyacrylates, polystyrene, polyester, polyamide, polyurethane, polyvinyl chloride, polyolefins, polyvinyl acetate, polyisoprene or poly(iso)butylene, for example, and also block copolymers thereof. The plasticizers, in accordance with DIN 55945, are liquid or solid inert organic substances with a low vapor pressure. On the basis of their solvency and swelling capacity, they reduce the hardness of the vinyl polymer and alter its adhesion. Examples of suitable plasticizers are phthalates, adipates, citrates, phosphates, trimellitic acid or sulfonic acid. The tackifiers are preferably rosin-based or hydrocarbon-based resins. Preferred crosslinkers are metal salts, such as zinc acetate, magnesium acetate or zirconium salts; aziridines, glyoxalates or triethylene glycol divinyl ether. Preferred rheology modifiers are polyurethane thickeners, acrylate thickeners, cellulose thickeners, polyvinyl alcohol thickeners, silicates, vinyl ether/maleic anhydride or polyethylene oxide. Preferred adhesion promoters are pH regulators (e.g., acrylic acid); silanes, aziridines or fluorine-based agents. Preferred stabilizers for raising the temperature stability are sterically hindered phenols, such as Irganox 110, Antioxidant 330 or Cyanox 2246, and for increasing the UV stability preferred stabilizers are sterically hindered phenols and/or sterically hindered amines, such as Irganox 1076 or 1010, Tinuvin P, Tinuvin 326 or 770, or Antioxidant 330, or modified titanium dioxides. Preferred defoamers are silicone-based, polyethylene oxide-based or liquid paraffin-based defoamers.

Preferred surfactants are wetting agents, such as anionic or cationic wetting agents or F- or Si-based wetting agents, with particularly preferred wetting agents being described on p. 152 and 516 in Handbook of Coatings Additives, Leonard J. Calbo, 1987, Marcel Dekker Inc., 0-8247-7561-9. Suitable drying additives include zirconium derivatives. The volatile organic compounds (VOCs) for the purposes of the invention are compounds having a vapor pressure of at least 0.1 mbar at 20° C. and a boiling point of not more than 240° C. at 1013.25 mbar. They are subdivided into solvents, with a boiling point below 150° C., and high boilers, with a boiling point between 150 and 240° C., as also defined in the Ordinance on Incentive Taxes on Volatile Organic Compounds (OVOC 814.018), part of the Swiss Law on Protection of the Environment (LPE from 1997) in the first section under Art. 1 (Definition). It is preferred to use from about 0 to about 3 parts by weight of volatile organic compounds, more preferably from about 0.1 to about 0.5 parts by weight of volatile organic compounds, based in each case on 100 parts by weight of sealant in the wet state. It is, however, also possible to use larger amounts of VOCs, as defined earlier on above. Solvents particularly suitable as VOCs are ethanol, propanol or ethyl acetate. High boilers particularly suitable as VOCs are glycols, such as ethylene glycol or propylene glycol. In addition, the sealant of the invention may also comprise further customary additives, examples being biocides (preservatives), as defined in Handbook of Coatings Additives, Leonard J. Calbo, 1987, Marcel Dekker Inc., 0-8247-7561-9, on page 195-197, or dyes.

Stabilizers are used especially when acrylate-based vinyl polymers with aliphatic monomers, such as vinyl acetate or butadiene, or aromatic monomers, e.g., styrene or vinylbenzene, are employed. Furthermore, it is preferred when using nonhydrogenated tackifiers to add an additional amount of stabilizers in order to obtain the desired aging stability. The function of the tackifiers, oligomeric fillers, and further organic fillers is to enhance the self-adhesiveness, cohesion, and water resistance of the sealant. Optimum cohesion can be achieved by the skilled worker through a choice of appropriate fillers and crosslinkers. In the construction segment said cohesion should be still adequate at 70° C. In this context the skilled worker can fine-tune the optimum cohesion by appropriately adapting the chain length of the vinyl polymer and the amount and quality of the fillers and crosslinkers. Since the optimization of cohesion is always in conflict with the adhesion, the cohesion must be chosen so that it is not set higher than the adhesion permits.

The additives are present in an amount of from about 0 to about 80 parts by weight, in particular from about 10 to about 70 parts by weight, most preferably from about 30 to about 60 parts by weight, based in each case on 100 parts by weight of sealant in the wet state. The abovementioned water-soluble additives added for the purpose of improving the frost resistance are present preferably in an amount of from about 0 to about 30 parts by weight, in particular from about 0 to about 15 parts by weight, while the other additives are present preferably in an amount of from about 0 to about 70, in particular from about 20 to about 50 parts by weight, based in each case on 100 parts by weight of sealant in the wet state.

The viscosity of the sealant in the wet state in accordance with ISO 2555 is preferably at least about 50 Pa.s at 23° C. when determined in accordance with Brookfield type A with a spindle 6 at 10 rpm. With preference the viscosity at 23° C. is at least about 200 Pa.s, more preferably at least about 350 Pa.s, in each case as determined in accordance with Brookfield type A with a spindle 7 at 10 rpm. The upper limit on the viscosity is defined by the sealant still being able to be handled. The appropriate viscosity can be set by the skilled worker in the course of tests which are customary in the art, using the abovementioned rheology modifiers and/or the other abovementioned additives. Rheology modifiers may also be added in order to facilitate the handling of the sealant. With the aid of rheology modifiers, such as thickeners or thixotropic agents, for example, a firm fluid sealant is obtained which is easy to express from a cartridge or a plastic bag and to process. At the same time, these modifiers raise the instantaneous strength, as a result of which the sealant is able to bear the weight, for example, of a polyolefin material. Wetting of the material to be sealed is achieved by means of surfactants. Since these surfactants may cause foaming, defoamers may be admixed. Repulsion of the sealant on the material to be sealed can in turn be prevented by increasing the viscosity using thickeners.

In accordance with the invention, the sealant in the dry state comprises at least one phase, which in the present specification is also referred to as the binding matrix. This phase contains the vinylpolymers and any additives soluble therein. The glass transition temperature, T_{g}, of the binding matrix is below about +10° C., preferably between about −80 and about +10° C., in particular between about −80 and about −40° C., the glass transition temperature, T_{g}, being determined by means of DSC (Differential Scanning Calorimetry) as follows. A sample of about 30 mg is first cooled at −10° C./min to −120° C. and then warmed at 10° C./min to 40° C. In the course of warming, there is a jump in the Cp curve (Cp denotes heat capacity) whose middle point defines the glass transition temperature, T_{g}. This middle point may also be determined by differentiating the curve. The use of plasticizers, oligomeric fillers and/or tackifiers also makes it possible to use vinylpolymers, especially polyacrylates, with a glass transition temperature higher than 10° C., since by means of said additives the glass transition temperature of the binding matrix can be lowered to the desired level. In general, the number of phases is determined by the composition of the sealant. Besides the binding matrix, the sealant preferably comprises at least one further phase, especially two further phases. This (these) further phase(s) contains (contain) water and additives which are not dissolved in the binding matrix.

In accordance with the invention, the dry state is the state attained by the sealant one hour following its application to Si paper at a weight of about 300 g/m² (dry) at 70° C. The wet state in the present specification refers to the state in which the sealant is obtained following its preparation and which it retains when stored, for example, in a plastic bag or a cartridge.

In the dry state, the sealant of the invention has a peel adhesion of at least about 5 N/25 mm, preferably from about 5 to about 50 N/25 mm, in each case as determined in accordance with DIN EN (European Norm [standard]) 1939 at between 5 and 50° C. on—for example—polyolefin materials. The sealant possesses this peel adhesion not only on polyolefin materials but also on all other materials, e.g., papers, nonwovens, polyamides or polyesters, but not on materials having a very low surface tension such as siliconized and fluorinated surfaces. The peel adhesion constitutes a repeated peel adhesion. This peel adhesion may be achieved by tailoring the polarity of the vinyl polymers, which is easy for the skilled worker to accomplish as part of tests which are common in the art. If the polarity of the vinyl polymer is too high, the affinity for a polyolefin material is too low, while if the polarity of the vinyl polymer is too low, there are too few double bonds present to achieve sufficient Van der Waals interactions with a polyolefin material. In this case the sealant must be formulated so that the adhesion (clinging) to polyolefinic materials is greater than the cohesion (internal strength) of the sealant. The polarity of the vinyl polymer, especially of the polyacrylate, can be tailored through the choice of monomers. Acrylate monomers with short ester groups, e.g., methyl or ethyl groups, have a high polarity, while acrylate monomers with long ester groups, e.g., stearyl acrylates, have a lower polarity. The polarity of a polyacrylate can also be optimized by using vinyl-based compounds, such as vinyl acetate, vinyl ethers, vinyl halides or vinylaromatic compounds, e.g., styrene. By adding divinyl or tervinyl comonomers it is possible to regulate the cohesion, molar mass, and shear modulus of the polymer.

The dynamic shear modulus G′ of the sealant in the dry state when determined in accordance with the measurement method below is situated preferably in the range from about 5·10⁵ Pa to about 5·10³ Pa at 25° C., in particular lower than about 5·10⁵ Pa at temperatures lower than −10° C., preferably lower than −25° C., and higher than about 5·10³ Pa at temperatures higher than 60° C., preferably higher than 80° C., in each case when determined in accordance with the following method. For the purposes of the present invention the shear modulus G′ is an elasticity modulus (or storage modulus) which is measured on a rheometer/plate/plate system at a frequency of 1 Hz, an extension of 0.2%, and warming at 5° C./min on a specimen with a thickness of 800 μm.

There are no restrictions on the preparation of the sealant. The above-mentioned components are mixed with one another preferably at a temperature from about 5 to about 100° C., with all common mixing systems being suitable for the mixing operation, static or dynamic mixers for example. It is advantageous to use mixers with programmable speed regulation, so that the production sequence can be specified. Preference is given to using mixers with high rotary speeds, the precise rotary speed being dependent on the composition of the sealant. If additives of high viscosity are used, it is appropriate to heat them before the mixing operation in order to facilitate said operation. Mixing takes place under vacuum, preferably at a pressure of from about 200 to about 80 mbar. The resulting paste is then dispensed into cartridges or plastic bags. In this packaging it can be kept for at least one year.

For use, the sealant is pressed using a pressure gun from the cartridge or the plastic bag. The sealant then dries by evaporation of the water. In the dry state, the sealant contains from about 0 to about 20% by weight of water, in particular from about 0 to about 10% by weight of water, based in each case on 100% by weight of the dried sealant.

The sealant can be processed within a temperature range from about 1 to about 60° C. The preferred processing temperature is from about 5 to about 50° C. If lower temperatures are required, suitable water-soluble additives, as described above, can be added in order to improve the frost resistance. In the dry state, the sealant fulfills its function in a temperature range from about −20 to about +80° C.

The sealant is used for sealing and/or connecting materials, especially connecting materials. Since the sealant adheres to all materials, such as polyolefins, papers, nonwovens, polyamides, and polyesters, with the exception of siliconized and fluorinated surfaces, it is used wherever such materials, especially polyolefin materials, are to be sealed, and especially where there are no exposed surfaces. The sealant may also, however, be employed wherever the continued presence of dirt is not disruptive. The sealants find use in particular in the construction sector, for pedestal strips, for profiles, especially polyolefin-containing profiles, or in the industrial sector. A special application in the construction sector is in the roof area, for connecting a polyolefin material to a solid substrate, e.g., a painted or unpainted wall of wood, plaster, concrete, limestone or brick. Examples of suitable polyolefin materials are films, webs, injection moldings, fibers, and cables.

Accordingly, preferred sealants of the invention have the following features and advantages:

substantially VOC-free, i.e., substantially solvent-free and high-boiler-free, and hence also low-odor;

in the dry state, peel adhesion on polyolefinic materials of at least 5 N/25 mm (in accordance with DIN EN 1939) at both 5° C. and 23° C.;

in the dry state, self-adhesive at from −20 to +80° C.;

aging-resistant, i.e., even on aging the peel adhesion does not fall below 5 N/25 mm (DIN EN 1939);

glass transition temperature of the binding matrix below 10° C.; and

can be processed with a cartridge and press gun.

Accordingly, the invention provides a sealant which is substantially VOC-free and exhibits good adhesion on polyolefin materials in particular.

The invention is illustrated with reference to the following example, which represents a preferred embodiment of the invention.

### EXAMPLE

60 parts by weight of a polyacrylate dispersion having a glass transition temperature T_{g}=−40° C., having a peel adhesion for PO materials of at least 15 N/25 mm and having a solids content of 65% by weight, of which about 99.5% by weight is polyacrylate and the remainder is emulsifiers, and containing 35% by weight of water are mixed with 6 parts by weight of water-soluble additive, namely 6 parts by weight of sodium sulfate, and with the following further additives at room temperature (23° C.) and 100 mbar: 9 parts by weight of resin, 7 parts by weight of polyamide fibers, 13 parts by weight of polyisobutylene, 1 part by weight of polyurethane thickener, 2 parts by weight of polyvinyl alcohol thickener, 0.3 parts by weight of UV stabilizer, 0.2 parts by weight of biocide and 0.5 parts by weight of surfactant. In the wet state, the paste has a viscosity of about 370 Pa.s (according to Brookfield, type A, spindle 7, 10 rpm) at 23° C. In the dry state, the composition obtained has a shear modulus G′ of 5·10⁵ Pa at −25° C. to 5·10³ Pa at 100° C. and a peel adhesion to polyolefin materials of 20 N/25 mm at 23° C. The dried sealant is self-adhesive, with measurement of the surface tack giving a traveling ball path of about 7 cm. The glass transition temperature of the binding matrix is −30° C. All measurements here were carried out in accordance with the methods of determination described above.

1. A one-component sealant based on a dispersion of vinyl polymers in an aqueous medium, wherein the sealant
in the wet state contains from 0 to 10 parts by weight of volatile organic compounds (VOCs), based on 100 parts by weight of sealant in the wet state, and in the dry state, which is defined as the state attained by the sealant one hour following its application to Si paper at a weight of about 300 g/m² (dry) at 70° C., is self-adhesive, with the path of a traveling ball being less than 30 cm in accordance with Test Methods for Pressure-Sensitive Adhesives, 6th edition, Pressure sensitive tape council, Itasca III,
has a peel adhesion when determined in accordance with DIN EN 1939 of at least 5 N/25 mm at between 5 and 50° C. on polyolefin materials, and
is composed of at least one phase whose glass transition temperature, T_{g}, is below 10° C.

2. The sealant of claim 1, characterized in that in the dry state it has a shear modulus G′ in the range from 5·10⁵ Pa to 5·10³ Pa at 25° C., of less than 5·10⁵ Pa at temperatures lower than −10° C., and of more than 5·10³ Pa at temperatures higher than 60° C.

3. The sealant of claim 1 or 2, characterized in that in the wet state, based in each case on 100 parts by weight of sealant, it is modified with from 0 to 80 parts by weight of additives, the additives containing less than 3 parts by weight of volatile organic compounds (VOCs).

4. The sealant of one of the preceding claims, characterized in that in the wet state it has a viscosity of at least 50 Pa.s at 23° C.

5. The sealant of one of the preceding claims, characterized in that the vinyl polymers comprise a polymer based on at least one acrylate and/or methacrylate monomer.

6. The sealant of one of the preceding claims, characterized in the wet state by a vinyl polymer content of from 15 to 90% by weight, based on 100% by weight of sealant.

7. The sealant of one of the preceding claims, characterized in the wet state by a vinyl polymer content of from 25 to 80% by weight, based on 100% by weight of sealant.

8. The sealant of one of claims 3 to 7, characterized in that the additives comprise at least one compound selected from water-soluble compounds, inorganic fillers, organic fillers, crosslinkers, adhesion promoters, stabilizers, defoamers, surfactants, drying additives, and volatile organic compounds (VOCs).

9. The sealant of claim 8, characterized in that the water-soluble compounds comprise at least one compound selected from sodium chloride, potassium chloride, calcium chloride, sodium sulfate, methanol, ethanol, propanol, acetone, ethyl glycol and propylene glycol.

10. The sealant of one of the preceding claims, characterized in that it is present in a cartridge or a plastic bag.

11. The use of a sealant of one of claims 1 to 10 for sealing and/or connecting materials.

12. The use of claim 11, wherein at least one material is a polyolefin material.

13. Materials coated with a sealant of one of claims 1 to 10.

14. A process for preparing a sealant of one of claims 1 to 10, characterized in that the components of the sealant are mixed with one another under vacuum.
